(19) United States
(12) Patent Application Publication
(10) Pub. No.: US 2026/0348109 A1
(43) Pub. Date: Nov. 5, 2026

(54) COMPOSITION AND METHOD FOR INTEGRATED ELASTOMERIC BALLAST IMPACT PROTECTION

(71) Applicant: Raymond Micucci, JR., Poughkeepsie, NY (US)

(72) Inventor: Raymond Micucci, JR., Poughkeepsie, NY (US)

(21) Appl. No.: 19/662,800

(22) Filed: Apr. 29, 2026

Related U.S. Application Data
(60) Provisional application No. 63/799,325, filed on May 2, 2025.

(51) Int. Cl. E01D 19/08; C08L 75/02

(52) U.S. Cl. CPC E01D 19/083; C08L 75/02; E01D 19/086; C08L 2203/14; C08L 2205/22; C08L 2207/24

(57) ABSTRACT

A composition and system for forming an integrated elastomeric ballast-protection mat over bridge decks. The composition includes a polyurea base material, a resilient rubber filler, and, in some embodiments, a foaming component to form a high-strength, energy-absorbing elastomer. The mat is applied above a waterproofing membrane and shaped to create a drainage profile, such as single-crown, double-crown, or cricket geometries, to direct water toward the bridge edges. Upon curing, the seamless protective layer provides enhanced resistance to ballast impact, abrasion, vibration fatigue, and thermal cycling while preventing moisture ingress and micro-puncture damage to the waterproofing layer.

### CROSS REFERENCE TO RELATED APPLICATIONS

This application claims priority from a U.S. Provisional Patent Appl. No. 63/799,325, filed on May 2, 2025, which is incorporated herein by reference in its entirety.

### FIELD OF INVENTION

The present invention relates to bridge deck drainage and protection systems. More particularly, the present invention is directed to compositions and methods for forming integrated elastomeric ballast impact protection layers over bridge decks to protect against ballast-related mechanical damage and environmental exposure.

### BACKGROUND

Bridge deck drainage and protection systems generally refer to a combination of materials and methods used to safeguard a bridge deck from deterioration caused by water infiltration and de-icing chemicals. Without adequate protection, moisture and chloride ions can penetrate the concrete, leading to corrosion of embedded steel reinforcement and long-term structural damage. These systems commonly integrate waterproofing materials with drainage components that channel water away from the deck surface to reduce surface accumulation and prevent ingress.

Conventional waterproofing techniques involve the application of an impermeable barrier over the concrete bridge deck to prevent penetration of water and de-icing salts. Various types of sheet membranes, such as polymer-modified bitumen or synthetic polymer sheets, are extensively used and bonded to the deck surface. Liquid-applied coatings, including epoxy-, polyurethane-, and acrylic-based compositions, are also commonly employed to form protective layers. Although these materials can improve moisture resistance, the bridge deck remains susceptible to mechanical damage from ballast abrasion and impact forces, particularly on railway bridges or structures subjected to loose stone ballast.

Therefore, there remains a need for improved compositions and application methods that provide both impermeable waterproofing and enhanced protection against ballast impact and abrasion, thereby increasing durability and operational safety of bridge decks.

### SUMMARY OF THE INVENTION

The following provides a simplified summary of one or more embodiments of the present invention to facilitate a basic understanding of its features and advantages. This summary is not an exhaustive overview of all contemplated embodiments and is not intended to identify essential elements or define the full scope of the invention. It merely introduces certain concepts that are described in greater detail in the subsequent sections.

The principal object of the present invention is to provide a composition and method for forming one or more ballast-impact protective layers on a bridge deck.

Another object of the present invention is to provide protective layers that are elastomeric and high strength to absorb and resist ballast impact forces.

Another object of the present invention is to enhance waterproofing protection of the bridge deck by integrating the ballast-impact protective layers with the underlying waterproofing membrane.

A further object of the present invention is to improve resistance to delamination or loosening under thermal cycling.

A further object of the present invention is to increase fatigue resistance and durability under repetitive vibration and dynamic loads.

A further object of the present invention is to reduce sub-surface crack initiation and propagation in the deck surface or waterproofing layer.

A further object of the present invention is to extend the service life of the underlying waterproofing and bridge deck structure.

A further object of the present invention is to reduce post-installation maintenance events and associated operational interruptions.

A further object of the present invention is to allow restoration of protective performance through localized or sectional re-coating without requiring full removal of the existing layer.

In one aspect, the present invention provides a system for ballast impact protection that mitigates kinetic shock energy imparted by aggregate ballast, fastener hardware, and other loose granular objects migrating on rail bridge decks under dynamic train loading. The disclosed elastomeric protective layer absorbs, dissipates, and redistributes localized point-load impacts, thereby preventing fracturing or puncturing of the waterproofing membrane and eliminating micro-puncture failure modes.

In another aspect, the present invention provides a composition for forming an integrated elastomeric ballast-protection mat. The composition comprises a base material, a resilient filler, and a foaming component. In some embodiments, the base material comprises polyurea, the resilient filler comprises ground rubber particles, and the foaming component comprises a two-component spray foam formulation.

In another aspect, the present invention provides a multi-layered protective system for shielding a bridge deck from ballast impacts while integrating water-drainage functionality. The system may include one or more water-drainage configurations such as single-crown, double-crown, or cricket geometries. The system further includes a waterproofing layer applied over the bridge deck, and the elastomeric ballast-impact protection layers are positioned to enhance the durability and service life of said waterproofing by providing mechanical protection against impact and abrasion.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a double crown configuration, according to an exemplary embodiment of the present invention.

FIG. 2 shows a single crown cricket configuration, according to an exemplary embodiment of the present invention.

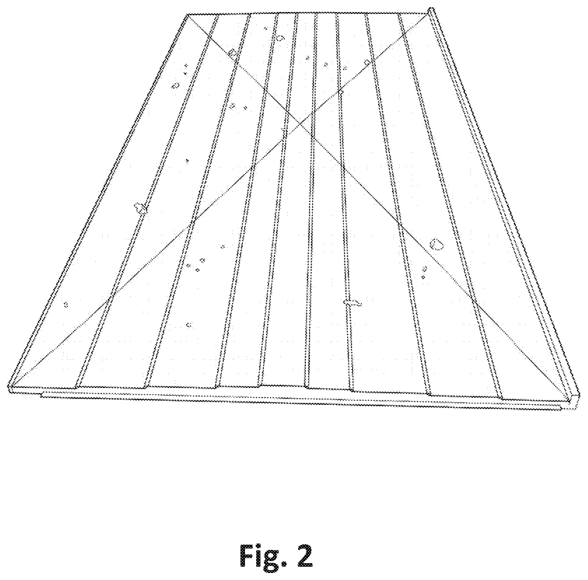

FIG. 3 illustrates dimensions of the double crown configuration, according to an exemplary embodiment of the present invention.

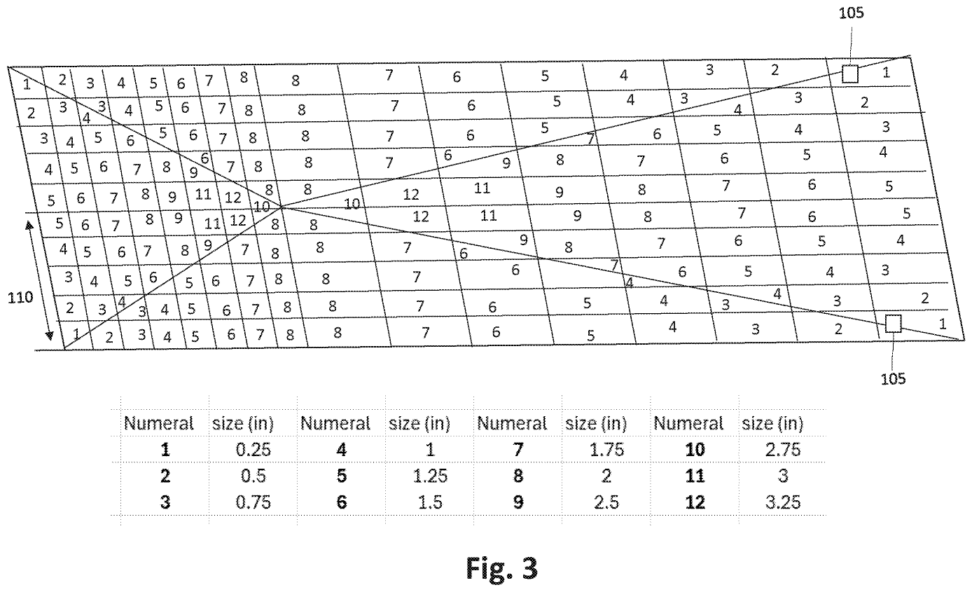

### DETAILED DESCRIPTION

The subject matter of the present invention will now be described more fully hereinafter. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The present invention pertains to a composition for forming an integrated elastomeric ballast-protection mat. Also disclosed is a ballast-protection mat for bridge decks, configured to protect the deck surface from ballast impact forces. The mat may be multilayered and formed from the disclosed composition, and is configured for use in conjunction with bridge-deck waterproofing layers or coatings. The mat can be installed in water-drainage configurations of the bridge deck, including single-crown, double-crown, and cricket geometries.

When applied in combination with an underlying waterproofing layer, the disclosed mat provides comprehensive protection by resisting ballast impacts, preventing moisture penetration, and facilitating efficient water drainage. The mat is capable of directing water toward the deck edges to prevent accumulation and promote rapid runoff. Due to its elastomeric properties, the mat expands and contracts with temperature cycling and dynamic loading without cracking or loss of adhesion, thereby providing long-term mechanical protection. The mat is applied over an existing or newly installed bridge-deck waterproofing system and may be integrated with the deck's drainage profile to further enhance durability and performance.

The composition includes a base material, a resilient filler, and a foaming component. In some embodiments, the base material comprises a polyurea resin system capable of forming a high-strength elastomeric matrix upon curing. The resilient filler comprises ground rubber particles, which may include vulcanized SBR (Styrene-Butadiene Rubber), EPDM (Ethylene-Propylene-Diene Monomer), natural rubber (NR), or combinations thereof. The ground rubber particles may be derived from recycled automotive tire feedstock or virgin rubber molding stock. The particles may exhibit a nominal particle-size distribution between approximately 0.5 mm and 9.5 mm in diameter to provide energy-absorbing characteristics while maintaining uniform dispersion within the cured elastomer.

In certain implementations, the composition comprises polyurea in a range of about 40-65 wt. % and ground rubber particles in a range of about 20-35 wt. %. In such implementations, the foaming component may be omitted.

In certain other implementations, the composition comprises polyurea in a range of about 40-60 wt. %, ground rubber particles in a range of about 20-30 wt. %, and the foaming component in a range of about 5-10 wt. %.

In certain implementations, the foaming component is a slow rise polyurea. It is a 2-component spray applied to expanding polyurea. The product may be 100% solids, for example 80 mil sprayed components turn to be 160 mils.

In certain implementations, the disclosed system is configured in the form of a double-crown cricket geometry. A primary advantage of the double-crown cricket configuration is that it enables effective water drainage on a flat bridge deck surface without the need for an inherently sloped steel deck structure, thereby reducing manufacturing costs.

In certain implementations, disclosed is a method in which the polyurea base material and ground rubber particles are co-applied without the foaming component.

In certain implementations, disclosed is a method in which the polyurea and foaming component are co-applied without the ground rubber particles.

In certain implementations, disclosed is a method for constructing the elastomeric ballast-protection mat. The method includes cleaning the bridge deck surface to remove dust, debris, oil, or other contaminants using any suitable technique, including dry vacuum cleaning or high-pressure wet cleaning. A primer layer may optionally be applied to the clean surface to promote adhesion. Suitable primers may include polyurea-compatible polyurethane, epoxy-amine, or moisture-cure formulations. The primer may be spray-applied or roller-applied to achieve a continuous wet film, typically between about 3 mils and 12 mils thickness.

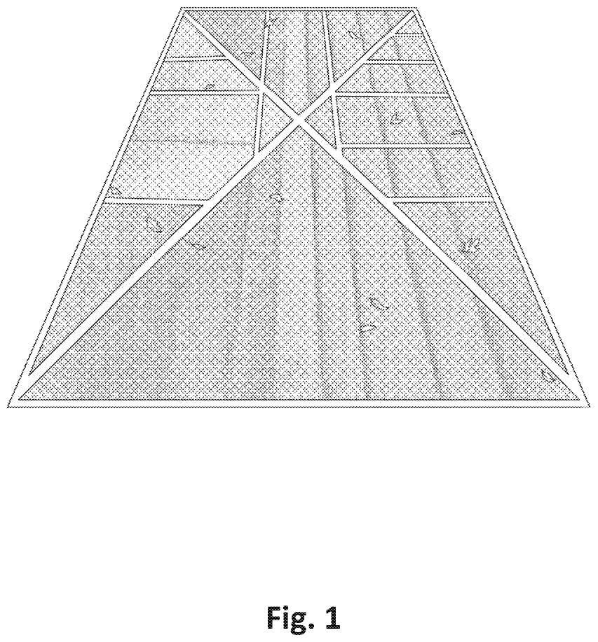

In certain implementations, the polyurea base material and ground rubber particles are mixed together to prepare the composition. The foaming component may be pre-mixed with the polyurea and rubber mixture, or may be introduced at the point of application. The prepared composition is applied in one or more layers over the primed bridge deck surface. In some embodiments, the applied thickness of the composition ranges from about 125 mils to about 5000 mils. The deposited material may be shaped or screeded into a multi-crown geometry to establish a drainage profile. After shaping, the applied layer is allowed to cure, forming a seamless, elastomeric, impact-resistant protective mat. FIG. 1 illustrates one example of a multi-crown drainage configuration.

### Example 1—Preparation of Multi-Crown Bridge Deck Installation

A representative formulation was prepared comprising approximately 60 wt. % polyurea, 30 wt. % ground rubber particles, and 10 wt. % spray-foam component. The mixture was applied onto a cleaned and prepared bridge deck surface to a total wet-film thickness of approximately 500 mils. The applied material was shaped into a multi-crown drainage geometry having a peak height of approximately 0.5 inches. The shaped profile cured in approximately 30 minutes to form the elastomeric ballast-protection mat.

Mechanical and performance testing demonstrated the following properties: adhesion strength greater than 350 psi (ASTM D4541), elongation of approximately 400% (ASTM D412), and impact resistance exhibiting no cracking or delamination (ASTM D2794). Drainage evaluation further demonstrated that water traversed the crown geometry and exited laterally in less than approximately 20 seconds.

The disclosed composition exhibited monolithic elastomeric behavior with localized energy absorption and return characteristics. These results demonstrate performance exceeding that of rigid sheet membranes and hard ceramic-filled polymer overlays, particularly with respect to impact damping, flexibility, and dynamic fatigue resistance.

In certain embodiments, the polyurea A-side and B-side components are delivered via plural-component heated proportioning equipment at a 1:1 volumetric ratio. When included, the ground rubber particles are metered through a side-port volumetric feeder directly into the polyurea spray plume during application to achieve uniform dispersion within the deposited elastomer.

In certain implementations, the disclosed system encompasses any spray-applied elastomeric system commercially utilized within the United States that is configured to provide ballast-impact mitigation and/or drainage contouring, including systems comprising aromatic polyurea, expanding polyurea foam, rubberized elastomeric fillers, or combinations thereof.

In certain implementations, the drainage function is integrated because the same elastomeric build forming the ballast-impact protective layer is placed to a profile that generates hydraulic slope for water conveyance.

### Water Drainage Configurations

Single-Crown Configuration: The single-crown design features a raised central ridge that slopes downward toward the lateral edges of the bridge deck, channeling water to the sides of the structure. This geometry facilitates rapid water removal and minimizes localized water accumulation that may otherwise compromise the underlying waterproofing membrane.

Double-Crown Configuration: The double-crown design enhances drainage capability by incorporating two raised longitudinal ridges separated by a central valley, enabling more efficient water distribution and flow. This configuration is particularly advantageous on substantially flat bridge decks where enhanced drainage performance is desired without requiring pitched steel decking.

Cricket Configuration: The cricket design incorporates raised or tapered sections oriented to divert water laterally toward designated drainage outlets. The cricket configuration may be used independently or in combination with the single-crown or double-crown geometries to address specific drainage requirements or localized ponding risks.

The disclosed elastomeric protective mat may be applied on concrete or steel rail bridge structures where ballast impact protection and integrated drainage are necessary. In some embodiments, the mat is applied directly over a bridge-deck waterproofing membrane, such as a Bridge Deck Membrane (BDM) system, provided that application occurs within approximately 12 hours of placement of the waterproofing layer. The system is suitable for both planar and geometrically irregular deck surfaces, with each drainage configuration (single-crown, double-crown, and cricket) adaptable to site-specific installation needs.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A composition for forming an elastomeric ballast-protection mat, the composition comprising:
a polyurea base material;
a resilient rubber filler dispersed within the base material; and
a foaming component configured to introduce an elastomeric cellular structure into the composition.

2. The composition of claim 1, wherein the resilient rubber filler comprises at least one of vulcanized SBR (styrene-butadiene rubber), EPDM (ethylene-propylene-diene monomer), NR (natural rubber), or blends thereof.

3. The composition of claim 1, wherein the resilient rubber filler is derived from recycled tire feedstock or virgin rubber molding stock.

4. The composition of claim 1, wherein the resilient rubber filler includes particles having nominal diameters between about 0.5 mm and about 9.5 mm.

5. A ballast-impact protection system for a bridge deck comprising:
a waterproofing membrane applied to the bridge deck; and
an elastomeric ballast-protection mat formed from the composition comprising:
a polyurea base material;
a resilient rubber filler dispersed within the base material; and
a foaming component configured to introduce an elastomeric cellular structure into the composition,
the elastomeric ballast-protection mat being shaped into a hydraulic-slope geometry configured to direct water toward a lateral edge of the bridge deck.

6. The system of claim 5, wherein the hydraulic-slope geometry comprises a single-crown profile.

7. The system of claim 5, wherein the hydraulic-slope geometry comprises a double-crown profile.

8. The system of claim 5, wherein the hydraulic-slope geometry comprises a cricket profile.

9. The system of claim 5, wherein the elastomeric ballast-protection mat is a monolithic layer having a thickness between about 125 mils and about 5000 mils.

10. The system of claim 5, wherein the elastomeric ballast-protection mat exhibits an elongation of at least 400% and an adhesion strength of at least 350 psi.

11. A method for protecting a bridge deck from ballast impact and water intrusion, comprising:
cleaning a surface of the bridge deck;
applying a waterproofing membrane to the cleaned surface;
preparing a composition comprising a polyurea base material and a resilient rubber filler; and
applying the composition over the waterproofing membrane to form an elastomeric ballast-protection mat.

12. The method of claim 11, further comprising shaping the applied composition to define a hydraulic-slope drainage geometry.

13. The method of claim 11, wherein the preparation further comprises introducing a foaming component into the composition before application.

14. The method of claim 11, wherein the preparation further comprises introducing a foaming component into the composition during application.
